(19) United States
(12) Patent Application Publication
(10) Pub. No.: US 2025/0327512 A1
(43) Pub. Date: Oct. 23, 2025

(54) POWERTRAIN SYSTEM

(71) Applicant: YANTAI JEREH PETROLEUM EQUIPMENT & TECHNOLOGIES CO., LTD., Yantai (CN)

(72) Inventors: Rikui ZHANG, Yantai (CN); Dong LIU, Yantai (CN); Zhuqing MAO, Yantai (CN); Peng ZHANG, Yantai (CN); Junlong DU, Yantai (CN)

(73) Assignee: YANTAI JEREH PETROLEUM EQUIPMENT & TECHNOLOGIES CO., LTD., Yantai (CN)

(21) Appl. No.: 19/177,048

(22) Filed: Apr. 11, 2025

Related U.S. Application Data
(63) Continuation of application No. PCT/CN2024/131624, filed on Nov. 12, 2024.

(30) Foreign Application Priority Data
Nov. 30, 2023 (CN) 202311635532.8

(51) Int. Cl. F16H 37/06; E21B 43/26; F04B 35/00; F16D 67/02; H02K 7/112; H02K 7/116

(52) U.S. Cl. CPC F16H 37/065; F04B 35/00; F16D 67/02; H02K 7/112; H02K 7/116; E21B 43/2607

(57) ABSTRACT

The present disclosure provides a powertrain system, including a turbine engine; a speed reduction mechanism, where the turbine engine is drivingly connected to at least a portion of the speed reduction mechanism, and the speed reduction mechanism is configured to drive a first load to move; and a power conversion mechanism, arranged between the speed reduction mechanism and the first load, where the power conversion mechanism has a first power connection state in which the first load is connected to the speed reduction mechanism and a first power disconnection state in which the first load is disconnected from the speed reduction mechanism. The technical solutions provided in the present disclosure address the conventional issue of the short service life of a power turbine of a turbine engine.

### CROSS-REFERENCE TO RELATED APPLICATIONS

This application is a continuation of and claims the benefit of priority to PCT International Patent Application PCT/CN2024/131624, filed on Nov. 12, 2024, which is based on and claims the benefit of priority to Chinese Patent Application No. 202311635532.8, filed with the China National Intellectual Property Administration on Nov. 30, 2023 and entitled “POWERTRAIN SYSTEM.” These prior applications are incorporated herein by reference in their entireties.

### TECHNICAL FIELD

The present disclosure relates to the power systems of fracturing equipment, and specifically, to a powertrain system.

### BACKGROUND

With development of fracturing equipment technologies in the conventional technology, fracturing equipment with turbine engines as power sources emerge. Compared with conventional diesel engines, the turbine engines have many advantages such as higher single-engine power density, the ability to use 100% natural gas as fuel to reduce fuel costs, and more environmental-friendly engine emissions. The turbine engine has an idling operating mode. In the idling operating mode, a compressor turbine in the turbine engine rotates and a power turbine has no power output. When the turbine engine is in the idling mode, to prevent a fracturing pump without a load or with a small load from being driven by the power turbine to rotate, a brake is mounted on a power output shaft of a high-speed planetary gearbox. In this way, once the turbine engine is in the idling mode, a rotational speed of the power turbine is forced to zero by the brake.

However, in the idling mode, a compressor, a combustion chamber, and the compressor turbine of the turbine engine are operating, and a large amount of burned natural gas is still discharged from an exhaust end of the turbine engine. After the burned natural gas is discharged from the combustion chamber, the burned natural gas passes through the compressor turbine first and drives the compressor turbine to rotate, to further drive the compressor to operate, and then the burned natural gas passes through the power turbine and is discharged from the exhaust end. In this process, the power turbine is subject to forced braking by the brake. Therefore, when the burned natural gas is discharged through the power turbine, the power turbine needs to withstand high temperatures and pressures of the burned natural gas. This affects a service life of the power turbine, resulting in a short service life of the power turbine.

### SUMMARY

An objective of the present disclosure is to provide a powertrain system to resolve a technical problem in the conventional technology that a service life of a power turbine of a turbine engine is short.

To achieve the foregoing objective, the present disclosure provides a powertrain system, including:
an engine;
a speed reduction mechanism, where the engine is drivingly connected to at least a portion of the speed reduction mechanism, and the speed reduction mechanism is configured to drive a first load to move; and
a power conversion mechanism, arranged between the speed reduction mechanism and the first load, where the power conversion mechanism has a first power connection state in which the first load is connected to the speed reduction mechanism and a first power disconnection state in which the first load is disconnected from the speed reduction mechanism.

In an embodiment, the power conversion mechanism includes:
a first clutch, where the first clutch is configured to be disengaged from or engaged with the speed reduction mechanism; or
a first clutch and a first brake, where when the first clutch is disengaged from the speed reduction mechanism, the first brake is configured to brake a power output section of the power conversion mechanism or a power input section of the first load, or when the first clutch is engaged with the speed reduction mechanism, the first brake releases the braking on the power output section of the power conversion mechanism or the power input section of the first load.

In an embodiment, the speed reduction mechanism includes:
a first speed reduction structure and a second load, where the engine is drivingly connected to the first speed reduction structure, the first speed reduction structure has a first power output end and a second power output end, the first power output end is drivingly connected to the first load, the second power output end is drivingly connected to the second load, and the first speed reduction structure is selectively and drivingly connected to the first load and/or the second load.

In an embodiment, the second load is an electric generator or an electromotor.

In an embodiment, the powertrain system further includes:
a speed governing mechanism, including a second speed reduction structure and a speed governing motor, where the second speed reduction structure has a first power input end and a second power input end, the first power input end is selectively connected to or disconnected from the first power output end, a power output section of the second speed reduction structure is drivingly connected to the first load, the second power input end is selectively connected to or disconnected from a power output section of the speed governing motor, and the second load is configured to be selectively connected to the speed governing motor to supply power to the speed governing motor.

In an embodiment, the speed governing mechanism further includes:
a switching mechanism, arranged between the second power input end and the speed governing motor, where the switching mechanism has a second power connection state in which the second power input end is connected to the speed governing motor and a second power disconnection state in which the second power input end is disconnected from the speed governing motor.

In an embodiment, the switching mechanism includes:
a second clutch, where the second clutch is configured to be disengaged from or engaged with the speed governing motor; and
a second brake, connected to the second clutch, where when the second clutch is disengaged from the speed governing motor, the second brake is configured to brake the second power input end, or when the second clutch is engaged with the speed governing motor, the second brake releases the braking on the second power input end.

In an embodiment, the first speed reduction structure includes:
a first power input shaft, where the first power input shaft forms a power input section of the first speed reduction structure;
a first planetary gear structure, where a power input section of the first planetary gear structure is connected to the power input shaft;
a first power output shaft, where the first power output shaft is connected to a power output section of the first planetary gear structure and forms the first power output end; and
a first parallel gear set, where the first parallel gear set is connected to the first power output shaft, and a power output section of the first parallel gear set forms the second power output end.

In an embodiment, the first planetary gear structure includes:
a first sun gear, a first planetary gear, a first planetary carrier, and a first annulus gear, where the first planetary gear meshes with the first sun gear, the first planetary gear is mounted on the first planetary carrier, the first planetary carrier is fixedly arranged, the first planetary gear drives the first annulus gear to rotate, and the first annulus gear is connected to the first power output shaft.

In an embodiment, the first speed reduction structure further includes:
a starter motor, selectively connected to or disconnected from the first planetary gear, to drive the first planetary gear to move through the starter motor or to be disengaged from the first planetary gear.

In an embodiment, the first speed reduction structure further includes:
a second parallel gear set, where the second parallel gear set is arranged between the starter motor and the first planetary gear, a first power connection section of the second parallel gear set is connected to the starter motor, and a second power connection section of the second parallel gear set is connected to the first planetary gear; and
a third clutch, arranged between a power input section of the second parallel gear set and the starter motor, where
when a rotational speed of the starter motor is greater than a rotational speed of the first power connection section, the third clutch is engaged to allow the starter motor to drive the first power connection section to rotate, or when the rotational speed of the starter motor is less than the rotational speed of the first power connection section, the third clutch is separated to allow the starter motor to be disengaged from the first power connection section.

In an embodiment, the second speed reduction structure includes:
a second power input shaft, where the second power input shaft has the first power input end;
a third power input shaft, where the third power input shaft has the second power input end;
a second planetary gear structure, where the second planetary gear structure includes a second sun gear, a second planetary gear, a second planetary carrier, and a second annulus gear, the second planetary gear meshes with the second sun gear, the second planetary gear is mounted on the second planetary carrier, the second planetary carrier is connected to the second power input shaft through the second sun gear, and the second annulus gear is connected to the third power input shaft; and
a second power output shaft, connected to the second planetary carrier, where the second power output shaft forms the power output section of the second speed reduction structure.

In an embodiment, the second speed reduction structure further includes:
a transmission gear, where the third power input shaft is connected to the transmission gear, and the transmission gear meshes with the second annulus gear to allow the third power input shaft to be connected to the second annulus gear through the transmission gear.

In an embodiment, the first load is a plunger pump; and
the plunger pump includes a third parallel gear set and a fluid end, which are connected to each other, and the power output section of the second speed reduction structure is connected to a power input section of the third parallel gear set; or
the plunger pump includes a third parallel gear set, a third planetary gear structure, and a fluid end, which are successively connected, the speed governing mechanism is arranged between the third parallel gear set and the third planetary gear structure, the third parallel gear set is arranged between the first power input end and the first power output end to allow the first power input end to be connected to the first power output end through the third parallel gear set, and the power output section of the second speed reduction structure is connected to a power input section of the third planetary gear structure.

In an embodiment, the turbine engine includes a single-shaft turbine engine, a double-shaft turbine engine, a triple-shaft turbine engine, a reciprocal engine, or an electric motor. Ion some other embodiment, the turbine engine may be replaced by an electric motor or other types of reciprocal engines (such as a diesel engine). The various other components above may be adjusted to the speed of these engines according.

According to technical solutions of the present disclosure, the power conversion mechanism is arranged, so that the first load has the first power connection state in which the first load is connected to the speed reduction mechanism and the first power disconnection state in which the first load is disconnected from the speed reduction mechanism, thereby facilitating power connection and disconnection, preventing a power turbine of the turbine engine from being subject to forced braking in an idling mode and preventing the power turbine from withstanding high temperatures and pressures of burned natural gas, enabling the power turbine to naturally rotate under the action of the burned natural gas, and avoiding technical difficulty that a service life of the power turbine is shortened due to forced braking on the power turbine.

### BRIEF DESCRIPTION OF DRAWINGS

Accompanying drawings of this specification that constitute a part of this application are used to provide further understanding of the present disclosure. Exemplary embodiments of the present disclosure and descriptions thereof are used to explain the present disclosure, and do not constitute an undue limitation on the present disclosure. In the drawings:

FIG. 1 is an example schematic diagram of a structure of a powertrain system without a speed governing mechanism according to an embodiment of the present disclosure;

FIG. 2 is an example schematic diagram of a structure of a powertrain system without a speed governing mechanism according to another embodiment of the present disclosure;

FIG. 3 is an example schematic diagram of a structure of a powertrain system according to an embodiment of the present disclosure;

FIG. 4 is an example schematic diagram of a structure of a power conversion mechanism according to an embodiment of the present disclosure;

FIG. 5 is an example schematic diagram of a structure of a speed reduction mechanism according to an embodiment of the present disclosure;

FIG. 6 is an example schematic diagram of a structure of a speed governing mechanism according to an embodiment of the present disclosure;

FIG. 7 is an example schematic diagram of a structure of a plunger pump according to an embodiment of the present disclosure;

FIG. 8 is an example schematic diagram of a structure of a powertrain system according to another embodiment of the present disclosure; and

FIG. 9 is an example schematic diagram of a structure of a plunger pump according to another embodiment of the present disclosure.

The foregoing accompanying drawings include the following reference numerals:
10. Turbine engine; 11. Compressor; 12. Combustion chamber; 13. Compressor turbine; 14. Power turbine;
20. Speed reduction mechanism; 21. First speed reduction structure; 211. First power input shaft; 212. First planetary gear structure; 2121. First sun gear; 2122. First planetary gear; 2123. First planetary carrier; 2124. First annulus gear; 213. First power output shaft; 214. First parallel gear set; 215. Starter motor; 216. Second parallel gear set; 217. Third clutch; 22. Second load;
30. Speed governing mechanism; 31. Second speed reduction structure; 311. Second power input shaft; 312. Third power input shaft; 313. Second planetary gear structure; 3131. Second sun gear; 3132. Second planetary gear; 3133. Second planetary carrier; 3134. Second annulus gear; 314. Second power output shaft; 315. Transmission gear; 32. Speed governing motor; 33. Switching mechanism; 331. Second clutch; 332. Second brake;
40. Power conversion mechanism; 41. First clutch; 42. First brake;
50. Plunger pump; 51. Third parallel gear set; 52. Third planetary gear structure; and 53. Fluid end.

### DESCRIPTION OF EMBODIMENTS

It should be noted that, if there is no conflict, embodiments in this application and the features in the embodiments may be combined with one another. The following describes the present disclosure in detail with reference to the accompanying drawings and embodiments.

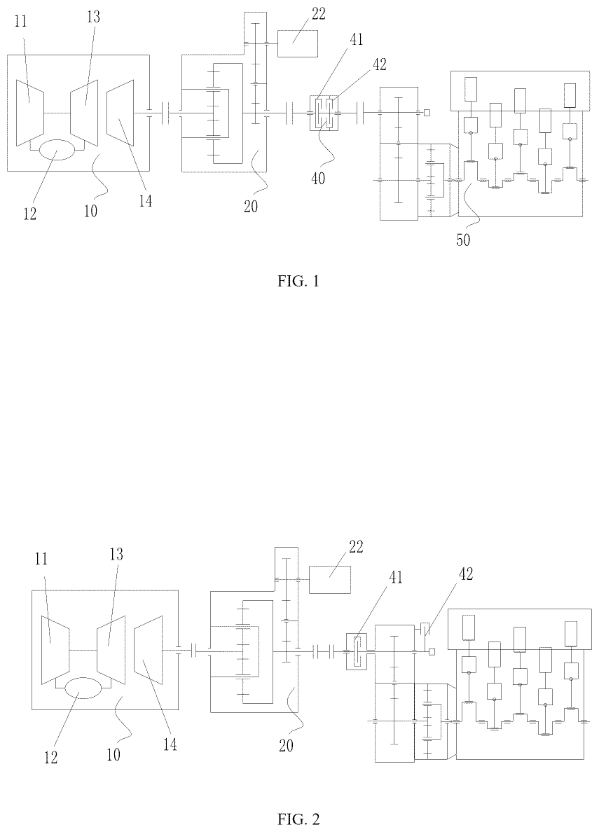

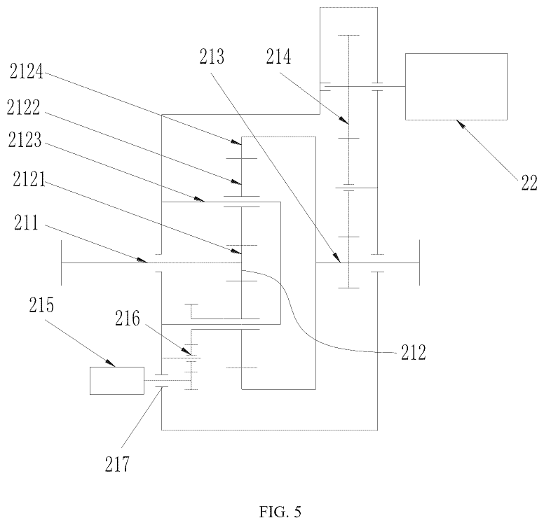

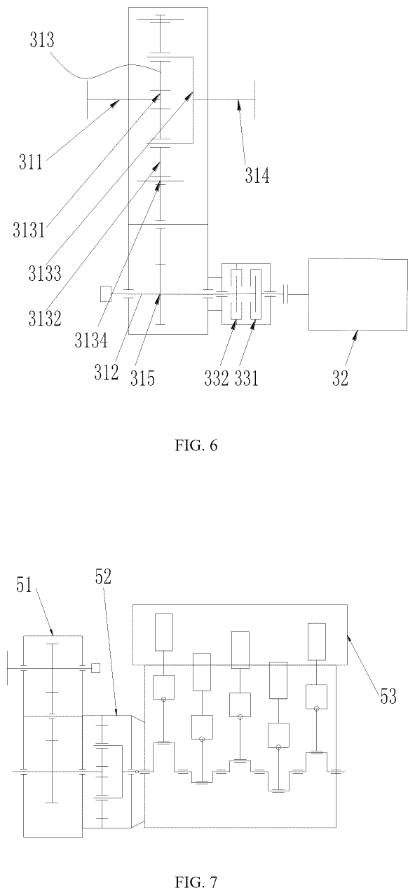

As shown in FIG. 1 to FIG. 9, an embodiment of the present disclosure provides a powertrain system. The powertrain system includes a turbine engine 10, a speed reduction mechanism 20, and a power conversion mechanism 40, where the turbine engine 10 is drivingly connected to at least a portion of the speed reduction mechanism 20, and the speed reduction mechanism 20 is configured to drive a first load to move. The power conversion mechanism 40 is arranged between the speed reduction mechanism 20 and the first load, and the power conversion mechanism 40 has a first power connection state in which the first load is connected to the speed reduction mechanism 20 and a first power disconnection state in which the first load is disconnected from the speed reduction mechanism 20.

By using the powertrain system provided in this embodiment, the power conversion mechanism 40 can enable the first load to have the first power connection state in which the first load is connected to the speed reduction mechanism 20 and the first power disconnection state in which the first load is disconnected from the speed reduction mechanism 20, thereby facilitating power connection and disconnection, preventing a power turbine of the turbine engine 10 from being subject to forced braking in an idling mode and preventing the power turbine from withstanding high temperatures and pressures of burned natural gas, enabling the power turbine to naturally rotate under the action of the burned natural gas, and avoiding technical difficulty that a service life of the power turbine is shortened due to forced braking on the power turbine.

In an embodiment, the power conversion mechanism 40 includes a first clutch 41, where the first clutch 41 is configured to be disengaged from or engaged with the speed reduction mechanism 20. Alternatively, the power conversion mechanism 40 includes a first clutch 41 and a first brake 42, where when the first clutch 41 is disengaged from the speed reduction mechanism 20, the first brake 42 is configured to brake a power output section of the power conversion mechanism 40 or a power input section of the first load, or when the first clutch 41 is engaged with the speed reduction mechanism 20, the first brake 42 releases the braking on the power output section of the power conversion mechanism 40 or the power input section of the first load. With such a structure arrangement, effective separation can be performed while braking is performed, and a case that operating of the turbine engine 10 continues to be affected when the turbine engine 10 is braked is avoided. In an embodiment, when a dual-spool turbine engine 10 is selected, and the dual-spool turbine engine 10 is in an idling mode, compared with braking alone, applying braking while engaging the clutch can effectively resolve a problem that a service life of the power turbine is affected by braking applied to the power turbine by the brake.

An operating principle of the power conversion mechanism 40 is that power transmitted from a power input section of the power conversion mechanism 40 is disengaged or engaged through the first clutch 41. The first brake 42 is responsible for braking on the power output section of the power conversion mechanism 40 when the first clutch 41 is disengaged, and releasing the braking on the power output section of the power conversion mechanism 40 when the first clutch 41 is engaged.

In this embodiment, the turbine engine 10 includes a compressor 11, a combustion chamber 12, a compressor turbine 13, and a power turbine 14.

In this embodiment, the speed reduction mechanism 20 includes a first speed reduction structure 21 and a second load, where the turbine engine 10 is drivingly connected to the first speed reduction structure 21, the first speed reduction structure 21 has a first power output end and a second power output end, the first power output end is drivingly connected to the first load, the second power output end is drivingly connected to the second load, and the first speed reduction structure 21 is selectively and drivingly connected to the first load and/or the second load. In an embodiment, the first speed reduction structure 21 may be drivingly connected to the first load; the first speed reduction structure 21 may be drivingly connected to the second load; or the first speed reduction structure 21 may be drivingly connected to the first load and the second load, to drive the first load and the second load to operate. In this way, operating conditions of the first load and the second load can be flexibly adjusted according to actual operating conditions.

In an embodiment, the second load is an electric generator, an electromotor, or an integrated starter generator.

In this embodiment, the powertrain system further includes a speed governing mechanism 30. The speed governing mechanism 30 includes a second speed reduction structure 31 and a speed governing motor 32, where the second speed reduction structure 31 has a first power input end and a second power input end, the first power input end is selectively connected to or disconnected from the first power output end, a power output section of the second speed reduction structure 31 is drivingly connected to the first load, the second power input end is selectively connected to or disconnected from a power output section of the speed governing motor 32, and the second load 22 is configured to be selectively connected to the speed governing motor 32 to supply power to the speed governing motor 32. The speed governing mechanism 30 is used to perform a speed governing operation, which eliminates the need for the turbine engine 10 to have a speed governing function, but it is only necessary to select a proper turbine engine 10 according to a required shape, size, and weight, thereby expanding a model selection range of the turbine engine 10.

In this embodiment, the powertrain system corresponds to three different operating modes, which are respectively an electric-only mode, an engine-only mode, and a hybrid mode. For the electric-only mode, the electric generator is connected to the speed governing motor 32 to supply power to the speed governing motor 32, the first power input end is disconnected from the first power output end, and the second power input end is connected to the power output section of the speed governing motor 32. For the engine-only mode, the first power input end is connected to the first power output end, and the second power input end is disconnected from the power output section of the speed governing motor 32. For the hybrid mode, the first power input end is connected to the first power output end, and the second power input end is connected to the power output section of the speed governing motor 32. In this way, different modes can be selected according to actual use needs to drive a to-be-driven component.

In an embodiment, the turbine engine 10 may be a single-spool (single-shaft), dual-spool (dual-shaft), or triple-spool (triple-shaft) turbine engine 10, and the turbine engine 10 may be a gas generator turbine. The turbine engine may be replaced with a reciprocal engine (piston engine, or diesel engine, and the like) or an electric motor. The electric generator may be a common electric generator or an integrated starter generator.

In this embodiment, the speed governing mechanism 30 further includes a switching mechanism 33. The switching mechanism is arranged between the second power input end and the speed governing motor 32, and the switching mechanism 33 has a second power connection state in which the second power input end is connected to the speed governing motor 32 and a second power disconnection state in which the second power input end is disconnected from the speed governing motor 32. With such a structure arrangement, the second power input end can be switched between different states in which the second power input end is connected to or disconnected from the speed governing motor 32, to implement smooth switching, thereby switching the powertrain system between different operating modes.

In an embodiment, the switching mechanism 33 includes a second clutch 331 and a second brake 332, and the second clutch 331 is configured to be disengaged from or engaged with the speed governing motor 32. The second brake 332 is connected to the second clutch 331. When the second clutch 331 is disengaged from the speed governing motor 32, the second brake 332 is configured to brake the second power input end, or when the second clutch 331 is engaged with the speed governing motor 32, the second brake 332 releases the braking on the second power input end. With such a structure arrangement, effective separation can be performed while braking is performed, and a case that a service life of the speed governing motor 32 is affected by braking is avoided, thereby prolonging the service life of the speed governing motor 32.

In this embodiment, the first speed reduction structure 21 includes a first power input shaft 211, a first planetary gear structure 212, a first power output shaft 213, and a first parallel gear set 214. The first power input shaft 211 forms a power input section of the first speed reduction structure 21, and a power input section of the first planetary gear structure 212 is connected to the first power input shaft 211. The first power output shaft 213 is connected to a power output section of the first planetary gear structure 212, and the first power output shaft 213 forms the first power output end. The first parallel gear set 214 is connected to the first power output shaft 213, and a power output section of the first parallel gear set 214 forms the second power output end. With such a structure arrangement, a speed reduction operation can be effectively performed, and the first power output end and the second power output end can be conveniently formed, so that power output switching is effectively performed.

In an embodiment, the first planetary gear structure 212 in this embodiment includes a first sun gear 2121, a first planetary gear 2122, a first planetary carrier 2123, and a first annulus gear 2124, where the first planetary gear 2122 meshes with the first sun gear 2121, the first planetary gear 2122 is mounted on the first planetary carrier 2123, the first planetary carrier 2123 is fixedly arranged, the first planetary gear 2122 drives the first annulus gear 2124 to rotate, and the first annulus gear 2124 is connected to the first power output shaft 213. With such a structure arrangement, a structure is simple, so that the speed reduction operation is stably performed.

In this embodiment, the first speed reduction structure 21 further includes a starter motor 215. The starter motor 215 is selectively connected to or disconnected from the first planetary gear 2122, to drive the first planetary gear 2122 to move through the starter motor 215 or to be disengaged from the first planetary gear 2122. With such a structure arrangement, external start-up assistance can be provided, so that the first planetary gear 2122 is stably started, and the first planetary gear 2122 is disengaged from the starter motor 215 after operating thereof is stable. In an embodiment, the starter motor 215 may be a turbine engine starter motor.

In an embodiment, the first speed reduction structure 21 in this embodiment further includes a second parallel gear set 216 and a third clutch 217, where the second parallel gear set 216 is arranged between the starter motor 215 and the first planetary gear 2122, a first power connection section of the second parallel gear set 216 is connected to the starter motor 215, and a second power connection section of the second parallel gear set 216 is connected to the first planetary gear 2122. The third clutch 217 is arranged between a power input section of the second parallel gear set 216 and the starter motor 215. When a rotational speed of the starter motor 215 is greater than a rotational speed of the first power connection section, the third clutch is engaged to allow the starter motor 215 to drive the first power connection section to rotate, or when the rotational speed of the starter motor 215 is less than the rotational speed of the first power connection section, the third clutch is separated to allow the starter motor 215 to be disengaged from the first power connection section. With such a structure arrangement, a rotational speed of the first planetary gear 2122 can be effectively increased when the rotational speed of the first planetary gear 2122 is low. After the first planetary gear 2122 is successfully started, the first planetary gear 2122 is smoothly separated from the starter motor 215, to prevent the starter motor 215 from affecting operating of the first planetary gear 2122.

In an embodiment, an operating principle of the speed reduction mechanism 20 is as follows: Upstream power is input through the first power input shaft 211 and drives the first sun gear 2121 to operate, the first sun gear 2121 drives the first planetary gear 2122 to operate, the first planetary carrier 2123 keeps fixed, the first planetary gear 2122 drives the first annulus gear 2124 to operate, and the first annulus gear 2124 drives the first power output shaft 213 to rotate, to implement output of main power. In addition, the first power output shaft 213 further drives the electric generator or the integrated starter generator to operate through the first parallel gear set 214, to implement a power generation function. The electric generator mainly supplies power to a motor for operating. There is a clutch between the starter motor 215 and the second parallel gear set 216. Once an output rotational speed of the second parallel gear set 216 exceeds the rotational speed of the starter motor 215, the clutch automatically disengages.

In this embodiment, the second speed reduction structure 31 includes a second power input shaft 311, a third power input shaft 312, a second planetary gear structure 313, and a second power output shaft 314, where the second power input shaft 311 has the first power input end, and the third power input shaft 312 has the second power input end. The second planetary gear structure 313 includes a second sun gear 3131, a second planetary gear 3132, a second planetary carrier 3133, and a second annulus gear 3134. The second planetary gear 3132 meshes with the second sun gear 3131, the second planetary gear 3132 is mounted on the second planetary carrier 3133, the second planetary carrier 3133 is connected to the second power input shaft 311 through the second sun gear 3131, and the second annulus gear 3134 is connected to the third power input shaft 312. The second power output shaft 314 is connected to the second planetary carrier 3133, and the second power output shaft 314 forms the power output section of the second speed reduction structure 31. With such a structure arrangement, an optimized layout of power input and output of the second speed reduction structure 31 can be smoothly implemented, so that a speed reduction structure can be optimized, and a speed reduction effect and a speed governing effect can be smoothly achieved.

In an embodiment, the second speed reduction structure 31 further includes a transmission gear 315, where the third power input shaft 312 is connected to the transmission gear 315, and the transmission gear 315 meshes with the second annulus gear 3134, to allow the third power input shaft 312 to be connected to the second annulus gear 3134 through the transmission gear 315. In an embodiment, the transmission gear 315 meshes with outer teeth of the second annulus gear 3134, to smoothly drive the second annulus gear 3134 to move through the transmission gear 315, thereby smoothly performing speed governing, and achieving an effective speed governing effect.

An operating principle of the speed governing mechanism 30 is as follows: Upstream power is input through the second power input shaft 311 to drive the second sun gear 3131 to rotate, the second sun gear 3131 drives the second planetary gear 3132 to rotate to further drive the second planetary carrier 3133 to rotate, and the second planetary carrier 3133 drives the second power output shaft 314 to rotate. In addition, a rotational speed of the second annulus gear 3134 is driven by the speed governing motor 32. Based on a single-row planetary gear set equation: nsun+αnannulus−(1+α)ncarrier=0, where nsun is a rotational speed of a sun gear, nannulus is a rotational speed of an annulus gear, ncarrier is a rotational speed of a planetary carrier, a is a ratio of a quantity of teeth zannulus of the annulus gear to a quantity of teeth zsun of the sun gear, that is, α=zannulus/zsun, and α>1, a rotational speed of a planetary carrier 3 is ncarrier=(nsun+αnannulus)/(1+α). Based on the foregoing formula, when the speed governing motor 32 outputs no rotational speed, the second clutch 331 is disengaged from power input of the speed governing motor 32, and the second brake 332 brakes the second annulus gear 3134, that is, the rotational speed of the second annulus gear 3134 is 0 in this case. In this case, a rotational speed of the second planetary carrier 3133 is ncarrier=nsun/(1+α), that is, an output rotational speed of a speed governing planetary gearbox is determined by only a speed ratio a of the second annulus gear 3134 to the second sun gear 3131. When the speed governing motor 32 operates, the second clutch 331 engages the power input of the speed governing motor 32, and the second brake 332 releases the braking on the second annulus gear 3134. In this way, the speed governing motor 32 drives the second annulus gear 3134 to rotate through the second clutch 331 and the transmission gear 315. In this case, the rotational speed of the second planetary carrier 3133 is n_{carrier}=(nₛᵤₙ+αnₐₙₙᵤₗᵤₛ)/(1+α). When a rotational speed of the speed governing motor 32 is the highest, that is, the rotational speed of the second annulus gear 3134 is correspondingly the highest, the rotational speed of the planetary carrier, that is, the output rotational speed of the speed governing gearbox, is maximum.

In this embodiment, the powertrain system further includes a plunger pump 50, where the plunger pump 50 forms a to-be-driven component.

In an embodiment, the plunger pump 50 includes a third parallel gear set 51 and a fluid end 53 that are connected to each other, and the power output section of the second speed reduction structure 31 is connected to a power input section of the third parallel gear set 51.

Alternatively, the plunger pump 50 includes a third parallel gear set 51, a third planetary gear structure 52, and a fluid end 53 that are successively connected. The speed governing mechanism 30 is arranged between the third parallel gear set 51 and the third planetary gear structure 52. The third parallel gear set 51 is arranged between the first power input end and the first power output end to allow the first power input end to be connected to the first power output end through the third parallel gear set 51, and the power output section of the second speed reduction structure 31 is connected to a power input section of the third planetary gear structure 52.

In an embodiment, a main operating principle of the plunger pump 50 is as follows: Upstream power is input through a power input section of the plunger pump 50, and is subject to speed reduction through the third parallel gear set 51 and the third planetary gear structure 52, to drive a crank inside a power output section of the plunger pump 50 to operate, and further drive a plunger to operate. Low-pressure suction and high-pressure pumping functions are implemented through the fluid end 53.

As shown in FIG. 1 and FIG. 2, the powertrain system in this embodiment does not include the speed governing mechanism 30. The first speed reduction structure 21 may be a high-speed gearbox. A power take-off is mounted on the high-speed gearbox to drive the load, and a clutch is mounted on a powertrain system between power output of the high-speed gearbox and power input of a fracturing pump, so that the turbine engine does not need to apply forced braking to the power turbine in the idling mode, and the power turbine freely rotates to drive the electric generator to generate power without overspeed, thereby avoiding a potential impact on a service life of the turbine engine.

A difference between the powertrain system in FIG. 1 and the powertrain system in FIG. 2 lies in a specific arrangement manner of the power conversion mechanism 40. As shown in FIG. 1, the first clutch 41 and the first brake 42 may be combined into one component, and a mounting position is located between a power output end of the high-speed gearbox and a power input end of a fracturing plunger pump. As shown in FIG. 2, the first clutch 41 is arranged between the power output end of the high-speed gearbox and the power input end of the fracturing plunger pump, the first brake 42 is spaced apart from the first clutch 41, and the first brake 42 is connected to the power input end of the fracturing plunger pump. A main operating principle is that power transmitted from a power input end of the high-speed gearbox is disengaged or engaged through the first clutch 41. The first brake 42 is responsible for braking the power output end when the first clutch 41 is disengaged, and releasing the braking on the power output end when the first clutch 41 is engaged.

An operating principle of the high-speed gearbox is as follows: Upstream power is input through a power input shaft to drive a sun gear to operate, the sun gear drives a planetary gear to operate, a planetary carrier keeps fixed, the planetary gear drives an annulus gear to operate, and the annulus gear drives a power output shaft to operate, to implement output of main power. In addition, the power output shaft further drives an electric generator or an integrated starter generator to operate through a parallel gear set, to implement a power generation function.

A main operating procedure of the powertrain system is described below.

Normal pumping operating mode of the fracturing plunger pump: In the normal operating mode of the fracturing plunger pump, power output of the turbine engine 10 is subject to speed reduction and torque increase through the high-speed gearbox. On the one hand, the second load 22 is driven to operate. On the other hand, the fracturing plunger pump is driven by a transmission shaft and the first clutch 41 to operate. In this case, the first clutch 41 is in an engaged state. The first brake 42 is in a non-braking state.

Idling mode of the turbine engine: When the turbine engine is in the idling mode, the second load 22 is in an operating state, the first clutch 41 is in a disengaged state, and the first brake 42 is in a braking state.

Shutdown mode of the turbine engine: When the turbine engine is in the shutdown mode, the first brake 42 is in the non-braking state, so that an operator performs turning gear maintenance on the fracturing plunger pump.

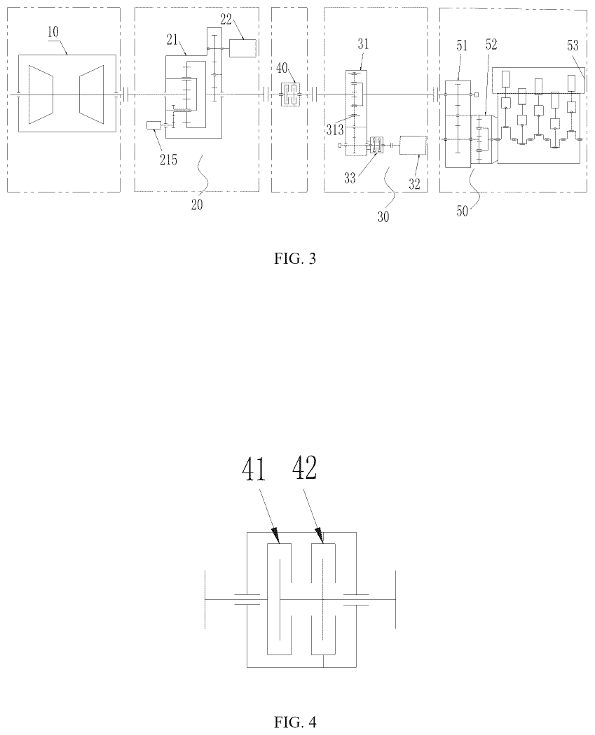

As shown in FIG. 3 to FIG. 7, in an embodiment, the power output section of the second speed reduction structure 31 is connected to the power input section of the third parallel gear set 51. It can also be understood as that the speed governing mechanism 30 and the plunger pump 50 are two independent structures, thereby facilitating model selection of the speed governing mechanism 30.

In this embodiment, an operating procedure of a corresponding powertrain system is as follows: Output power of a gas generator turbine 10 is subject to speed reduction and torque increase through a high-speed gearbox (corresponding to the speed reduction mechanism 20), passes through a power converter, and is further subject to speed reduction and torque increase through a speed governing planetary gearbox (corresponding to the speed governing mechanism 30), to drive the fracturing plunger pump 50 to operate. The powertrain system specifically has the following several operating modes.

(1) Electric-only mode: an operating mode in which a fracturing pump is directly driven by only a motor. In this mode, the first clutch 41 of the power converter is disengaged, and therefore, the output power of the gas generator turbine 10 is not transmitted to the speed governing planetary gearbox and the fracturing plunger pump 50. In addition, the first brake 42 of the power converter implements braking on the first sun gear 2121 of the speed governing planetary gearbox. In this mode, the gas generator turbine 10 may drive the high-speed gearbox to operate. Because an electric generator is mounted on the high-speed gearbox, this mode can implement a power generation function. In addition, in this mode, the first clutch 41 mounted on the speed governing planetary gearbox is engaged, the second brake 332 releases the braking on the second annulus gear 3134, the motor may drive the second planetary gear 3132 to operate by driving the second annulus gear 3134 to operate, and the power is output from the second power output shaft 314 through the second planetary carrier 3133 to drive the fracturing pump to operate. In this operating mode, flow regulation of the fracturing pump may be implemented through speed governing by the motor. The electric generator mounted on the high-speed gearbox can supply power to the motor mounted on the speed governing planetary gearbox.

(2) Engine-only mode: an operating mode in which a fracturing pump is directly driven by only the turbine engine 10. In this mode, the first clutch 41 of the power converter is engaged, and the first brake 42 releases braking. The motor on the speed governing planetary gearbox stops operating, the second clutch 331 is disengaged, and the second brake 332 brakes the second annulus gear 3134. The output power of the gas generator turbine 10 passes through the high-speed gearbox and the speed governing planetary gearbox to directly drive the fracturing plunger pump 50 to operate.

(3) Hybrid mode: a hybrid mode of direct driving by a turbine +speed governing by a motor. In this mode, a speed governing mode of the motor is enabled based on an operating mode of direct driving by a turbine. In an embodiment, the first clutch 41 of the power converter is engaged, and the first brake 42 releases braking. The second clutch 331 on the speed governing planetary gearbox is engaged, the second brake 332 releases the braking on the second annulus gear 3134, and the speed governing motor 32 operates, to drive the second annulus gear 3134 to operate. Based on the single-row planetary gear set equation of the planetary gearbox, the rotational speed of the second planetary carrier 3133 in this mode is ncarrier=(nsun+αnannulus)/(1+α). When the rotational speed of the speed governing motor 32 is the highest, that is, when the rotational speed of the second annulus gear 3134 is correspondingly the highest, the rotational speed of the second planetary carrier 3133, that is, the output rotational speed of the speed governing gearbox, is maximum.

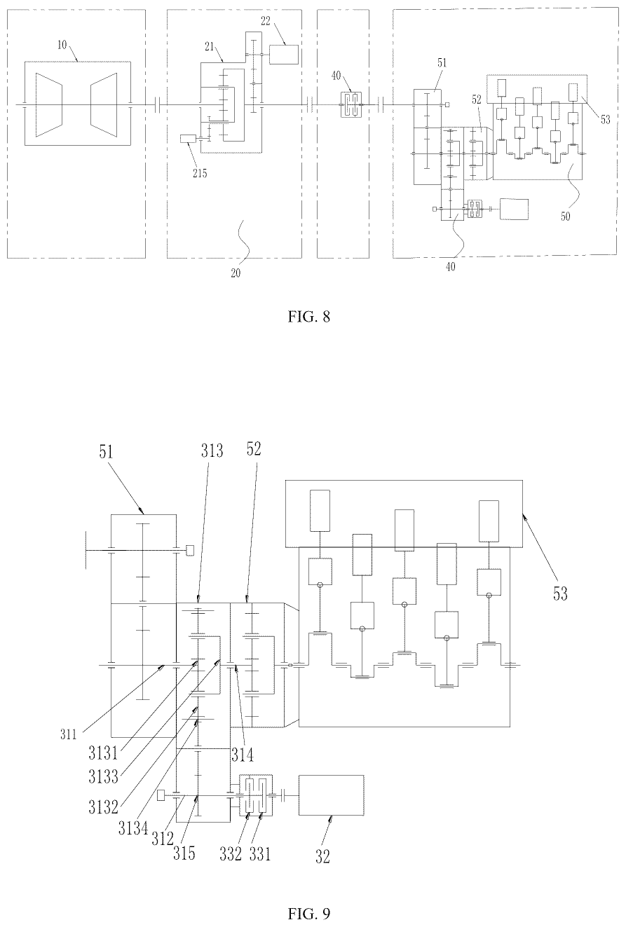

As shown in FIG. 8 and FIG. 9, in another embodiment, the speed governing mechanism 30 is arranged between the third parallel gear set 51 and the third planetary gear structure 52. The third parallel gear set 51 is arranged between the first power input end and the first power output end to allow the first power input end to be connected to the first power output end through the third parallel gear set 51, and the power output section of the second speed reduction structure 31 is connected to a power input section of the third planetary gear structure 52. It can also be understood that the speed governing mechanism 30 and the plunger pump 50 are of an integrated structure, which facilitates integrated mounting and operation, and simplifies an operation process of an operator.

In this embodiment, a main operating principle is as follows: Upstream power is input through the power input section of the plunger pump 50, and the power is transmitted to a third sun gear of the third planetary gear structure 52 after being subject to preliminary speed reduction through the third parallel gear set 51; the power is subject to speed reduction and torque increase through the speed governing planetary gearbox, and is output through a third planetary carrier of the third planetary gear structure 52; and the power passes through the third power input shaft 312 to drive the third sun gear of the third planetary gear structure, and the third sun gear drives a third planetary gear. Because a third annulus gear of the third planetary gear structure 52 is fixed, the power is output through a third power output shaft after passing through the third planetary carrier, to drive the crank of the fracturing plunger pump 50 to operate. The second planetary gear structure 313 is integrated between the third parallel gear set 51 and the third planetary gear structure 52 of the fracturing plunger pump 50.

In conclusion, the operating procedure of the powertrain system is as follows: The output power of the gas generator turbine 10 is subject to speed reduction and torque increase through the high-speed gearbox (the speed reduction mechanism 20), and passes through the power converter to drive the fracturing plunger pump 50 to operate. Particularly, a gearbox of the fracturing plunger pump 50 includes a third parallel gear set 51, a speed governing mechanism 30, and a third planetary gear structure 52. Further, the powertrain system has the following several operating modes.

(1) Electric-only mode: an operating mode in which a fracturing pump is directly driven by only a motor. In this mode, the first clutch 41 of the power converter is disengaged, and therefore, the output power of the gas generator turbine 10 is not transmitted to the fracturing plunger pump 50. In addition, the first brake 42 of the power converter brakes a driving gear in the third parallel gear set 51 of the fracturing plunger pump 50, to further brake the second sun gear 3131 of the speed governing mechanism 30. In this mode, the gas generator turbine 10 may drive the high-speed gearbox to operate. Because an electric generator is mounted on the high-speed gearbox, this mode can implement a power generation function. In addition, in this mode, the second clutch 331 mounted on the second planetary gear structure 313 on the fracturing plunger pump 50 is engaged, the second brake 332 releases the braking on the second annulus gear 3134 on the second planetary gear structure 313, the motor may drive the second planetary gear 3132 to operate by driving the second annulus gear 3134 to operate. Because the second sun gear 3131 is braked, the power is output from the second power output shaft 314 through the second planetary carrier 3133 to further drive the third sun gear of the third planetary gear structure 52 to operate. The third sun gear drives the third planetary gear, and then the power passes through the third planetary carrier and the third power output shaft of the third planetary gear structure 52 to drive the crank of the fracturing pump to operate. In this operating mode, flow regulation of the fracturing pump may be implemented through speed governing by the speed governing motor 32. The electric generator mounted on the speed reduction mechanism 20 can supply power to the speed governing motor 32 mounted on the second speed reduction structure 31.

(2) Engine-only mode: an operating mode in which a fracturing pump is directly driven by only the turbine engine 10. In this mode, the second clutch 331 of the power converter is engaged, and the second brake 332 releases braking. The motor on the second speed reduction structure 31 stops operating, the second clutch 331 is disengaged, and the second brake 332 brakes the second annulus gear 3134. The second sun gear 3131 of the second speed reduction structure 31 operates normally. The output power of the gas generator turbine 10 passes through the high-speed gearbox and the power converter, and is directly input through the power input end of the fracturing plunger pump 50. In this operating mode, the second annulus gear 3134 of the second speed reduction structure 31 is in a braked state and does not have a speed governing function.

(3) Hybrid mode: a hybrid mode of direct driving by a turbine +speed governing by a motor. In this mode, a speed governing mode of the motor is enabled based on an operating mode of direct driving by a turbine. In an embodiment, the first clutch 41 of the power converter is engaged, and the first brake 42 releases braking. The second clutch 331 on the speed governing mechanism 30 is engaged, the second brake 332 releases the braking on the second annulus gear 3134, and the speed governing motor 32 operates, to drive the annulus gear to operate. Based on the single-row planetary gear set equation of the planetary gearbox, the rotational speed of the second planetary carrier 3133 in this mode is ncarrier=(nsun+αnannulus)/(1+α). When the rotational speed of the speed governing motor 32 is the highest, that is, when the rotational speed of the second annulus gear 3134 is correspondingly the highest, the rotational speed of the second planetary carrier 3133, that is, a rotational speed of the second power output shaft 314 of the second speed reduction structure 31, is maximum.

From the foregoing description, it can be learned that the foregoing embodiments of the present disclosure implement the following technical effects: The model selection range of the turbine engine is expanded, and the service life of the turbine engine is prolonged.

It should be noted that the terms used herein are merely intended to describe specific implementations, and are not intended to limit exemplary implementations according to this application. As used herein, unless otherwise specified in the context expressly, the singular form is intended to include a plural form. In addition, it should be further understood that when the terms “comprise” and/or “include” are used in this specification, it indicates the presence of features, steps, operations, devices, assemblies, and/or combinations thereof.

The relative arrangements, numeric expressions, and values of the components and steps described in these embodiments are not intended to limit the scope of this application, unless otherwise specified. In addition, it should be understood that, for ease of description, dimensions of the parts shown in the accompanying drawings are not drawn according to an actual scale relationship. Technologies, methods, and devices known to a person of ordinary skill in the art may not be discussed in detail, but, where appropriate, the technologies, methods, and devices shall be considered as parts of this specification. In all the examples shown and discussed herein, any specific value should be interpreted as merely exemplary and not limiting. Therefore, other examples of exemplary embodiments may have different values. It should be noted that similar reference numerals and letters represent similar terms in the following accompanying drawings, and therefore, once a particular term is defined in one of the accompanying drawings, no further discussion is required in the subsequent accompanying drawings.

In the description of this application, it should be understood that azimuth or position relationships indicated by azimuth words such as “front, rear, upper, lower, left, right”, “lateral, vertical, perpendicular, horizontal”, and “top, bottom” are usually based on azimuth or position relationships shown in the accompanying drawings, and are merely for ease of description and simplification of this application. In a case in which no opposite description is provided, these azimuth words do not indicate or imply that the indicated apparatuses or elements must have specific azimuths or be constructed and operated in specific azimuths, and therefore, should not be construed as limiting the protection scope of this application. The azimuth words “inner” and “outer” refer to the inside and outside relative to the contours of the components.

For ease of description, spatially relative terms such as “over”, “above”, “on the surface of”, and “upper” may be used herein to describe a spatial position relationship between one device or feature and another device or feature shown in the accompanying drawings. It should be understood that the spatially relative terms are intended to include different azimuths in use or operation in addition to the azimuths of the devices that are described in the accompanying drawings. For example, if the devices in the accompanying drawings are inverted, the devices described as being “above or over other devices or configurations” would then be positioned “below or under other devices or configurations”. Therefore, the exemplary term “above” may include two azimuths: “above” and “below”. The devices may also be positioned in different manners (rotated by 90 degrees or in other azimuths), and the relative spatial description used herein is explained accordingly.

In addition, it should be noted that words such as “first” and “second” are used to limit a part, and are merely used to facilitate differentiation between corresponding parts. Unless otherwise specified, these words do not have any special significance and should not be construed as limiting the protection scope of this application.

The foregoing descriptions are merely embodiments of the present disclosure, and are not intended to limit the present disclosure. For a person skilled in the art, various modifications and changes may be made to the present disclosure. Any modification, equivalent replacement, improvement, and the like made within the spirit and principle of the present disclosure shall be included in the protection scope of the present disclosure.

What is claimed is:

1. A powertrain system, comprising:
an engine;
a speed reduction mechanism, wherein the engine is drivingly connected to at least a portion of the speed reduction mechanism, and the speed reduction mechanism is configured to drive a first load to move; and
a power conversion mechanism, arranged between the speed reduction mechanism and the first load, wherein the power conversion mechanism is configured to operate in one of:
a first power connection state in which the first load is connected to the speed reduction mechanism; or
a first power disconnection state in which the first load is disconnected from the speed reduction mechanism.

2. The powertrain system according to claim 1, wherein the power conversion mechanism comprises:
a first clutch configured to be disengaged from or engaged with the speed reduction mechanism.

3. The powertrain system according to claim 1, wherein the power conversion mechanism comprises:
a first clutch; and
a first brake,
wherein:
when the first clutch is disengaged from the speed reduction mechanism, the first brake is configured to brake a power output section of the power conversion mechanism or a power input section of the first load; or
when the first clutch is engaged with the speed reduction mechanism, the first brake releases the braking on the power output section of the power conversion mechanism or the power input section of the first load.

4. The powertrain system according to claim 1, wherein the speed reduction mechanism comprises:
a first speed reduction structure; and
a second load,
wherein:
the engine is drivingly connected to the first speed reduction structure;
the first speed reduction structure has a first power output end and a second power output end;
the first power output end is drivingly connected to the first load;
the second power output end is drivingly connected to the second load; and
the first speed reduction structure is selectively and drivingly connected to the first load and/or the second load.

5. The powertrain system according to claim 4, wherein the second load comprises an electric generator or an electromotor.

6. The powertrain system according to claim 4, further comprising a speed governing mechanism comprising a second speed reduction structure and a speed governing motor, wherein:
the second speed reduction structure has a first power input end and a second power input end;
the first power input end is selectively connected to or disconnected from the first power output end;
a power output section of the second speed reduction structure is drivingly connected to the first load;
the second power input end is selectively connected to or disconnected from a power output section of the speed governing motor; and
the second load is configured to be selectively connected to the speed governing motor to supply power to the speed governing motor.

7. The powertrain system according to claim 6, wherein the speed governing mechanism further comprises a switching mechanism arranged between the second power input end and the speed governing motor, wherein the switching mechanism is configured to operate in one of:
a second power connection state in which the second power input end is connected to the speed governing motor; or
a second power disconnection state in which the second power input end is disconnected from the speed governing motor.

8. The powertrain system according to claim 7, wherein the switching mechanism comprises:
a second clutch, wherein the second clutch is configured to be disengaged from or engaged with the speed governing motor; and
a second brake, connected to the second clutch,
wherein:
when the second clutch is disengaged from the speed governing motor, the second brake is configured to brake the second power input end; or
when the second clutch is engaged with the speed governing motor, the second brake releases the braking on the second power input end.

9. The powertrain system according to claim 6, wherein the first speed reduction structure comprises:
a first power input shaft, wherein the first power input shaft forms a power input section of the first speed reduction structure;
a first planetary gear structure, wherein a power input section of the first planetary gear structure is connected to the first power input shaft;
a first power output shaft, wherein the first power output shaft is connected to a power output section of the first planetary gear structure and forms the first power output end; and
a first parallel gear set, wherein the first parallel gear set is connected to the first power output shaft, and a power output section of the first parallel gear set forms the second power output end.

10. The powertrain system according to claim 9, wherein the first planetary gear structure comprises:
a first sun gear;
a first planetary gear;
a first planetary carrier; and
a first ring gear,
wherein:
the first planetary gear meshes with the first sun gear;
the first planetary gear is mounted on the first planetary carrier;
the first planetary carrier is fixedly arranged;
the first planetary gear drives the first ring gear to rotate; and
the first ring gear is connected to the first power output shaft.

11. The powertrain system according to claim 10, wherein the first speed reduction structure further comprises a starter motor selectively connected to or disconnected from the first planetary gear, and configured to drive the first planetary gear to move through the starter motor or to be disengaged from the first planetary gear.

12. The powertrain system according to claim 11, wherein the first speed reduction structure further comprises:
a second parallel gear set arranged between the starter motor and the first planetary gear, wherein a first power connection section of the second parallel gear set is connected to the starter motor, and a second power connection section of the second parallel gear set is connected to the first planetary gear; and
a third clutch arranged between a power input section of the second parallel gear set and the starter motor,
wherein:
when a rotational speed of the starter motor is greater than a rotational speed of the first power connection section, the third clutch is engaged to allow the starter motor to drive the first power connection section to rotate; or
when the rotational speed of the starter motor is less than the rotational speed of the first power connection section, the third clutch is disengaged to allow the starter motor to be disengaged from the first power connection section.

13. The powertrain system according to claim 12, wherein the second speed reduction structure comprises:
a second power input shaft comprising the first power input end;
a third power input shaft comprising the second power input end;
a second planetary gear structure comprising a second sun gear, a second planetary gear, a second planetary carrier, and a second ring gear, wherein the second planetary gear meshes with the second sun gear, the second planetary gear is mounted on the second planetary carrier, the second planetary carrier is connected to the second power input shaft through the second sun gear, and the second ring gear is connected to the third power input shaft; and
a second power output shaft connected to the second planetary carrier and forming the power output section of the second speed reduction structure.

14. The powertrain system according to claim 13, wherein the second speed reduction structure further comprises a transmission gear, wherein:
the third power input shaft is connected to the transmission gear; and
the transmission gear meshes with the second ring gear to allow the third power input shaft to be connected to the second ring gear through the transmission gear.

15. The powertrain system according to claim 6, wherein:
the first load comprises a plunger pump;
the plunger pump comprises a third parallel gear set and a fluid end, which are connected to each other, and
the power output section of the second speed reduction structure is connected to a power input section of the third parallel gear set.

16. The powertrain system according to claim 6, wherein:
the first load comprises a plunger pump;
the plunger pump comprises a third parallel gear set, a third planetary gear structure, and a fluid end, which are successively connected;
the speed governing mechanism is arranged between the third parallel gear set and the third planetary gear structure;
the third parallel gear set is arranged between the first power input end and the first power output end to allow the first power input end to be connected to the first power output end through the third parallel gear set; and
the power output section of the second speed reduction structure is connected to a power input section of the third planetary gear structure.

17. The powertrain system according to claim 1, wherein the engine comprises a single-shaft turbine engine, a double-shaft turbine engine, a triple-shaft turbine engine, a reciprocal engine, or an electric motor.
